(19) United States
(12) Patent Application Publication
(10) Pub. No.: US 2019/0389748 A1
(43) Pub. Date: Dec. 26, 2019

(54) METHOD OF ELECTRICAL TREATMENT DOSE SETTING FOR THE ELECTROLYTIC TREATMENT OF WASTE WATERS

(71) Applicant: MICROMET PTY LTD, Pooraka, South Australia (AU)

(72) Inventor: James Dunstone Townsend, Skye, South Australia (AU)

(73) Assignee: MICROMET PTY LTD, Pooraka, South Australia (AU)

(21) Appl. No.: 15/774,983

(22) PCT Filed: Nov. 10, 2016
(86) PCT No.: PCT/AU2016/000378

§ 371 Date: May 9, 2018

(30) Foreign Application Priority Data
Nov. 10, 2015 (AU) 2015904615

(51) Int. Cl. C02F 1/461

(52) U.S. Cl. CPC C02F 1/46109; C02F 2201/46175; C02F 2201/4614

(57) ABSTRACT

A waste water treatment apparatus comprising an electrode or electrode array, a DC power supply source (or supply sources) operably connected through a current modulator to the electrode or the electrode array, wherein the current modulator permits connection of the power supply to the electrode or electrode array and is itself operably connected to a pulse generator and a control system comprising at least the current modulator and the pulse generator which, in concert with the power supply is configured to provide a pulsing or modulating electrical DC current supply at variable frequency and variable duty cycle to the electrode or electrode array and to reverse the polarity of such current supply if, as and when required.

### PRIORITY DOCUMENT

The present application claims priority from Australian Provisional Patent Application No. 2015904615 titled “METHOD OF ELECTRICAL TREATMENT DOSE SETTING FOR THE ELECTROLYTIC TREATMENT OF WASTE WATERS” and filed on 10 Nov. 2015, the content of which is hereby incorporated by reference in its entirety.

### INCORPORATION BY REFERENCE

The following publication is referred to in the present application and its content is hereby incorporated by reference in its entirety:
U.S. Pat. No. 8,847,656 B1 titled “Approach for driving multiple MOSFETs in parallel for high power solid state power controller applications” in the name of Honeywell International Inc.

The following co-pending patent application is referred to in the following description:
PCT/AU2016/000181 titled “SACRIFICIAL ELECTRODE WITH PULSED CURRENT SUPPLY” and filed on 25 May 2016 claiming priority from Australian Provisional Patent Application No. 2015901914.

The content of this application is hereby incorporated by reference in its entirety.

### TECHNICAL FIELD

The present disclosure relates to electrolytic flocculation and water treatment systems.

### BACKGROUND

Population growth with the concomitant increasing volumes of wastewater produced, tighter wastewater quality regulations, increasing cost of clean water and water shortages, awareness for the protection of clean water sources and replacement of aging wastewater systems are driving an increasing demand for new waste water treatment technologies. Continuous flow, electrolytic flocculation and water treatment systems are known in the art and offer a useful alternative to known waste water treatment systems.

Electrolytic water treatment systems apply an electric charge to the waste water through an electrolytic cell immersed in the waste water containing electrolytes. The electrochemical reactions precipitate pollutants that are in a soluble state and these precipitated salts form a floc which is separated from the treated water.

In practice, it can be difficult to set the “dose” of electrical energy which the treatment system imparts to the waste water. One method of doing this known in the art is to vary both the flow of waste water to be treated and the voltage/amperage regime applied to the electrodes of the treatment system. By varying both the flow rate of the waste water and the voltage/amperage, it is possible to accurately apply a set dosage of electrical energy per unit volume of the waste water to be treated. In order to do this, it is necessary to be able to vary both the flow rate of the waste water entering treatment apparatus and the voltage applied to the power supplies, and hence the amperage, flowing to the electrode or electrodes.

For example, if the conductivity of the waste water were to fall, the control system may raise the voltage to maintain the same amperage at the same flow rate and hence the same “dose” of electrical energy per unit volume of water treated. If it were difficult or impossible to maintain the required amperage due to increased impedance of the electrode/electrolyte system, the system controller could then reduce the flow rate so as to maintain the same dose per unit volume of waste water treated, even though the current (amperage) may be reduced. Also, should the impedance of the electrode/electrolyte system decrease, then the voltage could be reduced and/or the flow rate increased to once again maintain a constant electrical energy dose to the waste water under treatment.

The design and implementation of such control systems can be complicated and expensive; and in practice the accurate variation of waste water flow rates, particularly in the case of physically difficult waste waters (such as sewage) can be difficult.

There is accordingly a need to provide a control system and method of electrical treatment dose setting for use in electrolytic waste water treatment systems which avoids these difficulties.

### SUMMARY

According to a first aspect, there is provided a waste water treatment apparatus comprising:

an electrode or electrode array;

a DC power supply source (or supply sources) operably connected through a current modulator to the electrode or the electrode array, wherein the current modulator permits connection of the power supply to the electrode or electrode array and is itself operably connected to a pulse generator;

a control system comprising at least the current modulator and the pulse generator which, in concert with the power supply is configured to provide a pulsing or modulating electrical DC current supply at variable frequency and variable duty cycle to the electrode or electrode array and to reverse the polarity of such current supply if, as and when required.

The control system is able to vary the modulation frequency for optimum efficacy of electrolytic treatment but, more particularly, vary the duty cycle of the DC current applied to the electrode(s) or electrode array(s) so as to maintain a constant average amperage to the electrode(s) or electrode array(s) even should the impedance of the electrode/electrolyte system suffer constant variation. This arrangement avoids the necessity of physical intervention to vary effluent flow rates which tends to be relatively slow, unreliable, difficult, expensive and prone to blockage with certain effluents. It will generally be necessary to provide each electrode or electrode array comprising the overall effluent treatment system with similar DC current supply arrangements.

According to a second aspect, there is provided a method for treating waste water comprising passing waste water to be treated though the apparatus of the first aspect of the invention.

### BRIEF DESCRIPTION OF THE FIGURE

Embodiments of the present invention will be discussed with reference to the accompanying FIGURE wherein:

FIG. 1 is a schematic representation of waste water treatment apparatus in accordance with an embodiment of the present disclosure.

In the following description, like reference characters designate like or corresponding parts throughout the FIGURES.

### DESCRIPTION OF EMBODIMENTS

Disclosed herein is a waste water treatment apparatus 10. The apparatus comprises an electrode or electrode array 2. A DC power supply source (or supply sources) 3 is/are operably connected through a current modulator 4 to the electrode or the electrode array 2. The current modulator 4 permits connection of the power supply 3 to the electrode or electrode array 2 and is itself operably connected to a pulse generator 5. A control system 6 comprises at least the current modulator 4 and the pulse generator 5. In concert with the power supply 3, the control system 6 is configured to provide a pulsing or modulating electrical DC current supply at variable frequency and variable duty cycle to the electrode or electrode array 2 and to reverse the polarity of such current supply if and when required.

As used herein, the term “waste water”, and variants thereof, means any water that has been adversely affected in quality by impurities. Wastewater can originate from a combination of domestic, industrial, commercial or agricultural activities, surface run off or stormwater, and from sewer inflow or infiltration. The term “waste water” includes within its scope effluent.

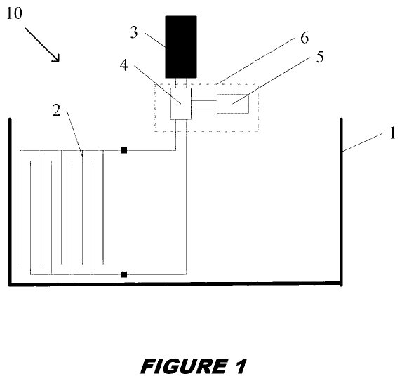

Referring now to FIG. 1, the waste water treatment apparatus 10 disclosed herein comprises a container vessel 1. The container vessel contains the electrode array 2. The waste water to be treated passes through the container vessel, coming under the influence of the electrode or electrode array 2 as it does so. Design elements to force the waste water into intimate contact with the electrode or electrode array 2 may be used in some embodiments. Special design elements may be incorporated into the design of the vessel 1 at the entrance and exit of the container vessel 1 so that the waste water passes more efficiently through the electrode or electrode array(s) 2 and so that the waste water maintains a set level within the container vessel.

The container vessel 1 may be a stand-alone apparatus or it may be a component of a modular waste water treatment apparatus 10 comprising a plurality of water treatment chambers connected in series, as is known in the art.

The container vessel 1 may have any suitable dimensions (width, height and/or depth) and be any suitable shape. The container vessel 1 may be formed from any suitable material, such as fibreglass, metal, plastics, etc. Suitable vessels are known in the art. The vessel 1 comprises a waste water inlet and a treated water outlet, as is known in the art.

The electrode array 2 is supported within the container vessel. The electrode array 2 may be any configuration. Each electrode array 2 is connected to a power supply 3 and control system 6 as shown.

In the embodiment shown in FIG. 1, the electrode array 2 comprises at least two electrodes with each electrode in a pair of electrodes having opposite polarity. One of the electrodes in each electrode pair is a sacrificial electrode. There may be any number of pairs of electrodes in the array. In the electrode array 2 shown in FIG. 1, there are four pairs of electrodes in the array. There could also be one, two, three, five, six, seven, eight, nine or ten pairs of electrodes in the electrode array 2. The electrode array and water treatment apparatus may be the same as, or similar to, the one described in our co-pending International (PCT) Patent Application No. PCT/AU2016/000181 titled “SACRIFICIAL ELECTRODE WITH PULSED CURRENT SUPPLY”, the details of which are incorporated herein in their entirety.

The electrode array 2 is supported in the container vessel 1 in any suitable way. The configuration of the electrodes 2 themselves is not particularly important and, for example, they may be in the form of plates, expanded mesh, cylinders, and the like. It is advantageous for the surface area of the electrodes 2 to be as large as possible. In the illustrated embodiments, the electrodes 2 are plates that are held substantially parallel and spaced from one another.

The anode (which is sacrificial) may be an iron or aluminium electrode. The counter electrode, which is the cathode, may be any conductive material and, for example, could be stainless steel, iron, aluminium, and the like.

When a voltage is applied across the electrodes metal ions from the sacrificial anode electrode (e.g. Fe³⁺ or Al³⁺) are released into the water. The released metal ions act as a flocculant and binds to particulate matter in the water. Oxygen gas is also produced at the anode electrode and hydrogen is produced at the cathode electrode and the bubbles of these gases assists in bringing the flocculated material to the surface of the water.

The electrode array 2 is operably connected to the control system 6 and power supply 3 as shown in FIG. 1. In turn, the power supply 3 is connected to the electrode array 2.

The current modulator 4 is configured to rapidly and efficiently switch the current on and off. It is also configured to reverse the flow direction of the current to lessen or prevent passivation of the electrode array 2.

The pulse generator 5 generates pulses to set the overall pulsing frequency and the duty cycle. The pulses control the current modulator 4 and thus the flow of DC current to the electrode or electrode array 2.

The control system 6 comprises the pulse generator 5 and the current modulator 4, which work together with the power supply 3 to set the modulation frequency and the duty cycle of the DC current applied to the electrode or electrode array 2. The current modulator 4 and pulse generator 5, or current modulator 4, pulse generator 5 and power supply 3 could be incorporated into a single, purpose designed device. The control system 6 may further comprise a microcontroller.

The power supply provides a (relatively high amperage) DC current flow, and is connected to the electrode array 2 through the current modulator 4. The current modulator 4 is connected to the pulse generator 5 as shown in FIG. 1.

Because the current modulator 4 is able to switch the DC current output of the power supply 3 on and off very rapidly, the switching control signal from the pulse generator 5 to the current modulator 4 is able to control not only the frequency at which the power pulses on and off, but also the duty cycle of the DC current output.

The current modulator 4 is able to achieve this highly efficient and rapid switching function by the use of MOSFETs (metal oxide/semiconductor field effect transistors). An example of a system suitable for driving MOSFETs for direct current solid state power controller applications can be found in U.S. Pat. No. 8,847,656.

If the duty cycle of the power supply DC output is small (low percentage of time switched “ON”) then the average DC current flow will also be relatively low. Conversely, if the duty cycle of the power supply is large (high percentage of time switched “ON”) then the average DC current flowing to the electrode(s) will be relatively high. Therefore, the control system 6 is able to manipulate the duty cycle as required to maintain a pre-set dose of electrical energy per volume of treated effluent even though the impedance of the electrode/electrolyte system may vary while the flow remains constant.

In use, the flow rate of waste water into the apparatus is held substantially constant. The control system 6 is configured to apply a pre-set dose of electrical energy per volume of treated waste water.

The control system 6 is also configured to provide a modulated flow of DC current to the electrode(s) 2 at a set frequency.

In specific embodiments, the control system 6 is configured to manipulate the duty cycle of the DC current flowing to the electrode(s) 2 so as to maintain the average amperage at a steady, pre-set level and thus maintain a pre-set dosage of electrical energy per unit volume of effluent passing through the treatment system.

In specific embodiments, the control system 6 is configured such that the current modulator 4 can also reverse the polarity of the DC current flow to the electrodes 2 while retaining the ability to manipulate the duty cycle and frequency of the reversed flow should this be required.

Also provided herein is a method of treating waste water, the method comprising passing waste water to be treated though the apparatus of the first aspect of the invention.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A waste water treatment apparatus comprising:
an electrode or electrode array;
a DC power supply source (or supply sources) operably connected through a current modulator to the electrode or the electrode array, wherein the current modulator permits connection of the power supply to the electrode or electrode array and is itself operably connected to a pulse generator;
a control system comprising at least the current modulator and the pulse generator which, in concert with the power supply is configured to provide a pulsing or modulating electrical DC current supply at variable frequency and variable duty cycle to the electrode or electrode array and to reverse the polarity of such current supply if, as and when required.

2. The apparatus of claim 1, wherein the flow rate of waste water is held substantially constant.

3. The apparatus of claim 1, wherein the control system is configured to apply a pre-set dose of electrical energy per volume of treated waste water.

4. The apparatus of claim 3, wherein the control system is configured to provide a modulated flow of DC current to the electrode(s) at a set frequency.

5. The apparatus of claim 1, wherein the control system is configured to manipulate the duty cycle of the DC current flowing to the electrode(s) so as to maintain the average amperage at a steady, pre-set level and thus maintain a pre-set dosage of electrical energy per unit volume of waste water passing through the treatment system.

6. The apparatus of claim 1, wherein the control system is configured such that the modulator can also reverse the polarity of the DC current flow to the electrodes, while retaining the ability to manipulate the duty cycle and frequency of the reversed flow should this be required.

7. A method of treating waste water, the method comprising passing waste water to be treated though the apparatus of claim 1.
